(19) United States
(12) Patent Application Publication
(10) Pub. No.: US 2015/0068535 A1
(43) Pub. Date: Mar. 12, 2015

(54) TREATMENT TABLE

(71) Applicant: Anthony J. Dicesaro, Pittsburgh, PA (US)

(72) Inventor: Anthony J. Dicesaro, Pittsburgh, PA (US)

(21) Appl. No.: 14/277,715

(22) Filed: May 14, 2014

Related U.S. Application Data
(60) Provisional application No. 61/823,263, filed on May 14, 2013.

(51) Int. Cl. A61G 13/10; A61G 13/12

(52) U.S. Cl. CPC A61G 13/107; A61G 13/129; A61G 13/126
USPC 128/845

(57) ABSTRACT

A treatment table configured with vertical and horizontal supports, wherein one or more cushions are positioned on the top of the supports to provide a surface for treating a patient. One portion of the cushion supporting the body of the patient has an aperture positioned therethrough for allowing the treatment to be applied to pass through the body cushion from beneath the patient. The lower horizontal support can also be provided with rails and/or a bracket provided to allow one or more treatment devices to be employed in a consistent manner to treat a patient.

### CROSS REFERENCE TO RELATED APPLICATIONS

This application claims priority to U.S. Provisional Patent Application No. 61/823,263, filed May 14, 2013, the entirety of which is incorporated herein by reference.

### BACKGROUND OF THE INVENTION

1. Field of the Invention

The present invention relates generally to treatment tables and related mechanisms for treatment tables, and, more particularly, to an improved treatment table having securing and positioning mechanisms that allow for efficient positioning of one or more treatment devices in one or more areas of interest for selectively positioning the one or more treatment devices relative to one or more treatment targets.

2. Description of Related Art

Various procedures in the healthcare field and otherwise, use various emitters to treat patients for various ailments or elective treatments. These emitters vary based upon the needed treatment and may include electromagnetic radiation, laser, LED, etc.

It is well known that problems often arise when attempting to keep the emitter in place during treatment in relation to the one or more treatment areas and/or targets. Patients often lie, face-up or down on a horizontal table throughout the duration of the treatment and options are limited for placement of the treatment devices often operated by hand. In many situations holding is required, and technicians may have to use props or other makeshift devices to attempt to adequately hold the treatment device in a desired position for the desired amount of application in areas of interest for treatment. Such holding is physically demanding, and custom crafting any such makeshift props or devices time consuming, both of which can yield less than optimal treatments and introduce undesirable risks to parties involved with treatments.

Further, excess working space for storage of treatment equipment costs money and increases risk of damage to the treatment equipment. Further, keeping the treatment equipment stored elsewhere may increase the safety risks of transport and handling by the technician.

As alluded to above, problems may arise with current techniques and makeshift props where treatment may not be properly provided due to faulty and/or inconsistent positioning, wherein the same patient may be required to undergo revisionary treatment adding to the costs and time to complete the desired treatment procedure.

### SUMMARY OF THE INVENTION

Accordingly, it is one object of the present invention to provide an improved treatment table with securing and positioning mechanisms that overcomes many of the drawbacks and deficiencies of the prior art systems and arrangements. It is another object of the present invention to permits efficient securing and positioning of treatment devices toward areas of interest for selective positioning with respect to an area of interest and/or treatment target of a patient. In addition, another object of the invention is to provide more accurate treatment that may reduce treatment times allowing for more treatments in shorter intervals between treatments.

In accordance with an embodiment of the present invention, a treatment table may include at least two substantially vertical supports, a first support in communication with the at least two substantially vertical supports at a first height and a second support in communication with the at least two substantially vertical supports above the first height. The treatment table may further include at least one rail in communication with the first support and be configured to slidably support a treatment device. Further, a first cushion may be provided that is in communication with the second support and that may have a first aperture positioned through the first cushion above the rail.

In accordance with an embodiment of the present invention, a treatment table may include at least two substantially vertical supports, a first support in communication with the at least two substantially vertical supports at a first height, and a second support in communication with the at least two substantially vertical supports above the first height. The treatment table may also include a first cushion in communication with the second support that has a first aperture through the first cushion above the second support and a translucent member configured to substantially cover the first aperture.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended to unduly limit the present invention. As used in the specification and the claims, the singular form of “a”, “an”, and “the” include plural referents unless the context clearly dictates otherwise.

### BRIEF DESCRIPTION OF THE DRAWINGS

FIG. 1 is a perspective view of an embodiment of a treatment table in accordance with the present invention;

FIG. 2 is a top view of an embodiment of a treatment table in accordance with present invention;

FIG. 3 is a side view of an embodiment of a treatment table in accordance with present invention;

FIG. 4 is an end view of the treatment table shown in FIG. 3;

FIG. 5 is an exploded view of an embodiment of a treatment table in accordance with present invention;

FIG. 6 is a perspective view of an embodiment of a treatment table in accordance with the present invention;

FIG. 7 is a perspective view of an embodiment of an upper support for a treatment device in accordance with the present invention; and

FIG. 8 is an end view of an embodiment of a treatment table in accordance with the present invention.

### DESCRIPTION OF THE PREFERRED EMBODIMENT(S)

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and/or step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as unduly limiting.

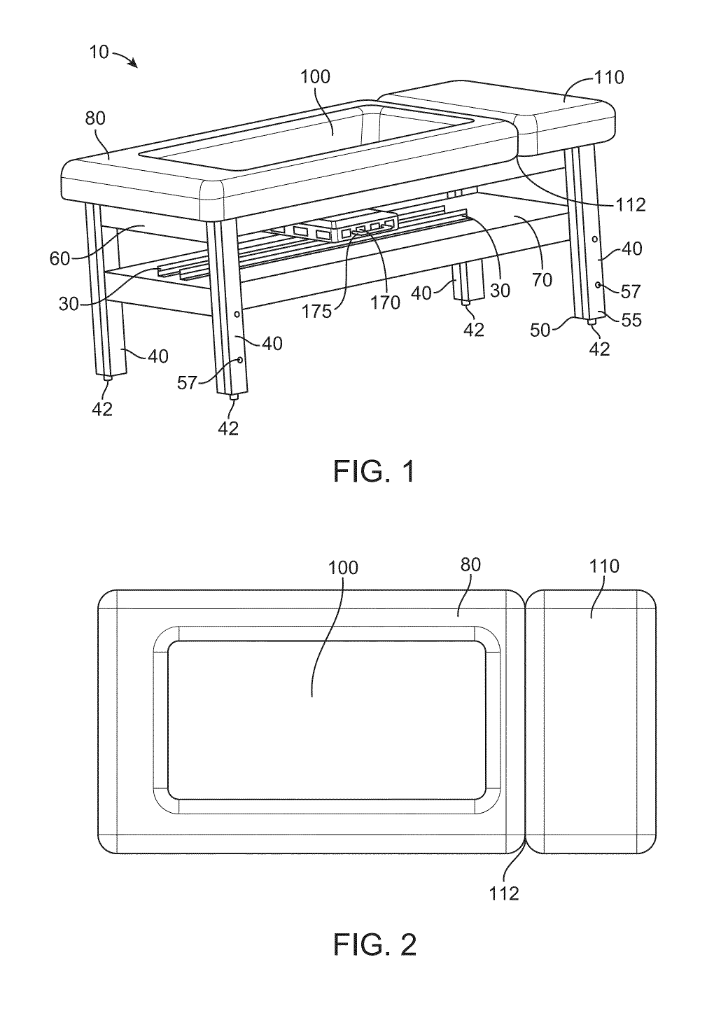

The present invention is directed to a treatment table 10, which is illustrated in various preferred and non-limiting embodiments in FIGS. 1-8. The treatment table 10 may include one or more vertical supports 40, an upper support 60 and a lower support 70. As can be seen in FIG. 1, the lower support 70 may also have rails 30 mounted thereto for supporting and selectively positioning (or orienting) a treatment device 170 with respect to a treatment target (not shown) positioned on the treatment table 10 such as, for example, a patient.

The treatment table 10, in one embodiment and as shown in FIGS. 1-2, may further include a cushion body 80, and a cushion head 110 supported by the vertical supports 40 and/or the upper support 60. The cushion body 80 may further include a treatment aperture 100 positioned therethrough. Further, the cushion body 80, in various embodiments and as shown in FIGS. 1-3, may also be connected to the cushion head 110 via a hinge 112 positioned between along the adjacent edges of the cushion body 80 and the cushion head 110.

As can be seen in FIGS. 1 and 3-4, the lower support 70 may support rails 30, along which the treatment device 170 may travel. Accordingly, in order to assist in the translation of treatment device 170 by a technician (not shown), a handle 175 may be provided thereon. As will be discussed in greater detail below, the treatment device 170 may be used to treat a treatment target, or area of interest, on a patient through the treatment aperture 100 as shown in FIG. 1. In addition, in accordance with the present invention, the treatment device 170 may be a number of desired devices to provide various treatments including, but not limited to, electromagnetic radiation, laser, LED, etc.

Further, as shown in FIGS. 1, 3-6 and 8, vertical supports 40 may be provided with feet 42 that may be adjustable in order to position the cushions 80, 110 at a desired height and or slope. In addition, vertical supports 40 may comprise multiple components including one or more fixed legs 50 and corresponding adjustable legs 55. Accordingly, fasteners 57 may be used to secure one or more fixed legs 50 to corresponding adjustable legs 55 through apertures 56.

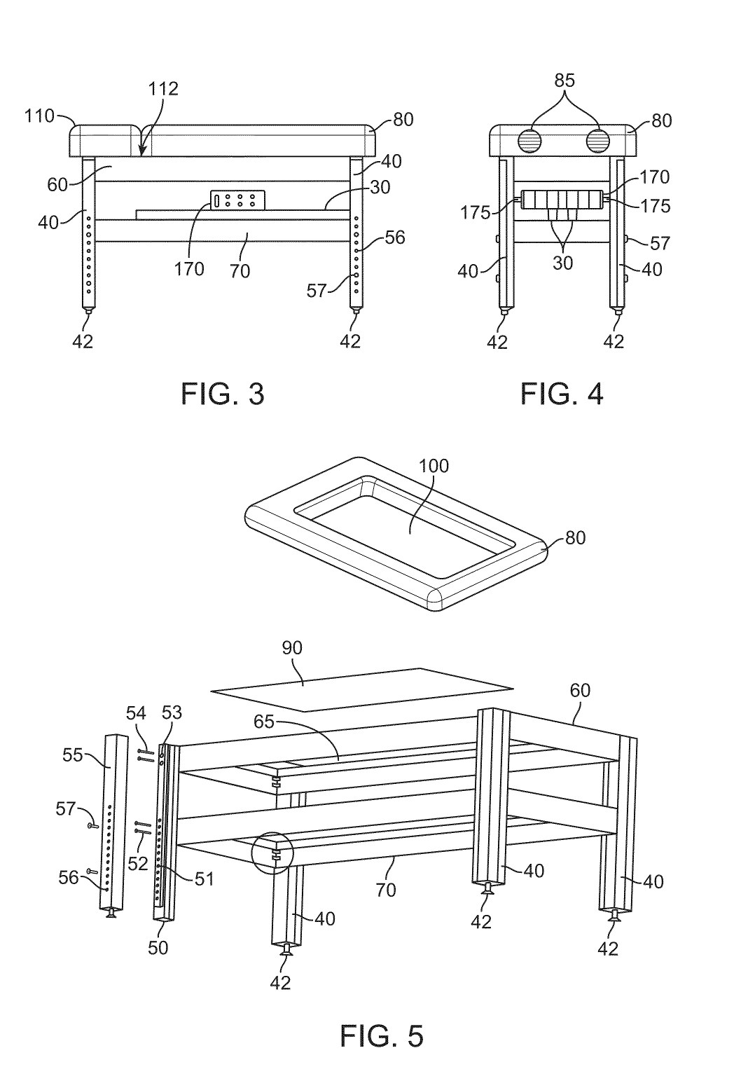

More specifically, concerning FIGS. 3-5, the fixed leg 50 may have apertures 51 therethrough to enable fasteners 52 to adjustably secure the lower support 70 at a desired height. Accordingly, the present invention allows for the treatment device 170 to be adjusted to a desired distance from the cushion body 80. Further, each fixed leg 50 may also have a corresponding adjustable leg 55 to allow for further height adjustment of the cushions 80, 110. Adjustable legs 55 thus have apertures 56 through which fasteners 57 may be positioned into fixed leg 50.

FIG. 4 shows vents 85 that may be positioned in cushion body 80 so as to provide ventilation for one or more areas. Thus, ventilation may be provided between the patient and a translucent member 90 via vents 85. In addition, vents 85 may extend though the cushion body 80 downward so as to provide ventilation to heat created by the treatment device 170 as well. Further, vents may be outfitted with fans 85 to create powered ventilation where desired in accordance with the present invention.

As can be seen in FIG. 5, the upper support 60 may also have an aperture 65 positioned therethrough that corresponds to the treatment aperture 100 of the cushion body 80. In addition, upper support 60 may be secured to the vertical supports 40 via fasteners 54 positioned through apertures 53. In one preferred embodiment, a translucent member 90 may be provided to create a barrier between the patient and the treatment device 170, wherein translucent member may be supported by the upper support 60 as can be seen in FIGS. 5-6 and 8.

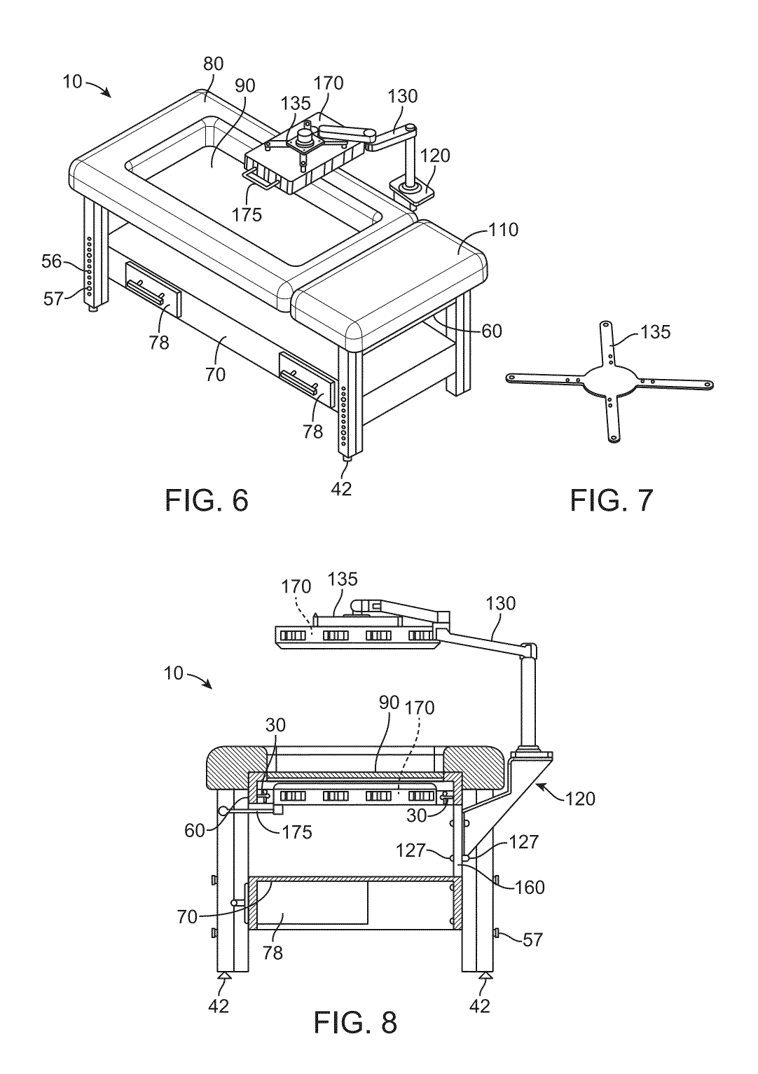

In one embodiment, and as shown in FIG. 6, the treatment table 10 may have a treatment device 170 positioned above the cushions 80, 110. As discussed above, the treatment device 170 may further have a handle 175 to facilitate positioning and applying treatments by the technician (not shown) to a treatment target or area of interest. Accordingly, the treatment device 170 may be secured to an articulating arm 130 via mounting bracket 135 shown in FIG. 7. Further, the articulating arm 130 may be supported via bracket 120 secured beneath the cushions 80, 110. In accordance with the present invention, the articulating arm 130 may take a variety of forms for selectively positioning and orienting the treatment device 170 in a desired area of interest with respect to the patient via multiple joints, knuckles, arms, etc. The bracket 120 may also take a variety of forms for securing the articulating arm 130 as required for a given application, and as discussed in great detail below with regards to FIG. 7. Drawers 78 may also be provided in the lower table support 70, as shown in FIGS. 6, 8.

In another preferred and non-limiting embodiment of the treatment table 10, according to the present invention, is illustrated in FIG. 6. In this embodiment, there are dual treatment devices 170, wherein one treatment device 170 is positioned above the cushions 80, 110 and another is positioned below the same. Accordingly, a technician may be able to treat multiple treatment targets and/or areas of interest simultaneously.

The treatment device 170 positioned below the cushions 80, 110 may be mounted in close proximity to the cushions 80, 110 as shown in FIG. 8 for varied treatments as preferred by the technician or based upon the needs of the patient. Thus, rails 30 may be mounted to the upper support 60 so as to enable the treatment device 170 under the cushions to travel nearly adjacent to the translucent member 90. Further, as discussed above, the treatment device 170 may further be provided with a handle 175 to assist in the translation of the treatment device 170 beneath cushion body 80.

As can be seen in FIG. 8, the bracket 120 supports the articulating arm 130 via support 160. The support 160 may be secured between upper support 60 and the lower support 70 so as to provide a stable base for the bracket 120. Accordingly, one or more fasteners 127 may secure the bracket 120 to the support 160.

Accordingly, the present invention provides a treatment table that allows for the selective positioning of treatment device with respect to a treatment target and/or area of interest of a patient. Through the use of the novel integrated and adjustable supports as described herein, the treatment device does not need to be brought to and from the patient for each and every treatment providing varying quality and reliability of desired treatments.

Although the invention has been described in detail for the purpose of illustration based on what is currently considered to be the most practical and preferred embodiment(s), it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment. Since other modifications and changes varied to fit particular operating requirements and environments will be apparent to those skilled in the art, the invention is not considered limited to the example chosen for purposes of disclosure, and covers all changes and modifications which do not constitute departures from the spirit and scope of this invention.

The invention claimed is:

1. A treatment table comprising:
at least two substantially vertical supports;
a first support in communication with said at least two substantially vertical supports at a first height;
a second support in communication with said at least two substantially vertical supports above said first height;
at least one rail in communication with said first support and configured to slidably support a treatment device; and
a first cushion in communication with said second support and having a first aperture positioned therethrough above said rail.

2. The treatment table of claim 1, wherein at least one of said at least two substantially vertical supports comprise a first fixed support configured to be releasably secured to a first adjustable support.

3. The treatment table of claim 1, further comprising third supports each adjustably supporting one of said at least two vertical supports.

4. The treatment table of claim 1, further comprising a second cushion positioned adjacent said first cushion.

5. The treatment table of claim 4, further comprising a hinge in communication with said second cushion and positioned between said first cushion and said second cushion.

6. The treatment table of claim 1, further comprising a translucent member configured to substantially cover said first aperture.

7. The treatment table of claim 1, further comprising one or more second apertures not coincident with said first apertures.

8. The treatment table of claim 1, further comprising a bracket configured to support a treatment device.

9. The treatment table of claim 8, wherein said at least one rail is configured to slidably support a first treatment device below said first aperture and said bracket is configured to support a second treatment device above first aperture.

10. The treatment table of claim 1, further comprising at least one drawer in communication with said first support.

11. A treatment table comprising:
at least two substantially vertical supports;
a first support in communication with said at least two substantially vertical supports at a first height;
a second support in communication with said at least two substantially vertical supports above said first height;
a first cushion in communication with said second support and having a first aperture positioned therethrough above said second support; and
a translucent member configured to substantially cover said first aperture.

12. The treatment table of claim 11, wherein at least one of said at least two substantially vertical supports comprise a first fixed support configured to be releasably secured to a first adjustable support.

13. The treatment table of claim 11, further comprising third supports each adjustably supporting one of said at least two vertical supports.

14. The treatment table of claim 11, further comprising a second cushion positioned adjacent said first cushion.

15. The treatment table of claim 14, further comprising a hinge in communication with said second cushion and positioned between said first cushion and said second cushion.

16. The treatment table of claim 11, further comprising one or more second apertures not coincident with said first apertures.

17. The treatment table of claim 11, further comprising a bracket configured to configured to support a treatment device.

18. The treatment table of claim 17, further comprising a slidable mount for supporting a treatment device below the first aperture.

19. The treatment table of claim 11, further comprising at least one drawer in communication with said first support.
